(19) United States
(12) Patent Application Publication
(10) Pub. No.: US 2025/0259072 A1
(43) Pub. Date: Aug. 14, 2025

(54) AUTOMATED SINGLE-TO-GROUPED CLOUD COMPUTING OPTIMIZATION

(71) Applicant: Kyndryl, Inc., New York, NY (US)

(72) Inventors: Keri Wheatley, Sevierville, TN (US); Gail Camille Guerrero, Plano, TX (US); Omar Odibat, Cedar Park, TX (US); Umar Mohamed Iyoob Umar, Pflugerville, TX (US)

(21) Appl. No.: 18/436,070

(22) Filed: Feb. 8, 2024

(51) Int. Cl. G06N 3/092; G06N 7/01

(52) U.S. Cl. CPC G06N 3/092; G06N 7/01

(57) ABSTRACT

Embodiments relate to a technique for providing automated single-to-grouped cloud computing optimizations. The technique includes generating, by a first machine learning model, a single notification for a computing environment, and in response to receiving user responses to a string of the single notification and other single notifications for the computing environment, determining to switch from a single mode to a group mode. The technique includes, based on the user responses to the string of the single notification and the other single notifications for the computing environment, generating, by a second machine learning model, a group of notifications for the computing environment. The technique includes causing at least one modification to the computing environment in accordance with at least one affirmative user response to the group of notifications.

### BACKGROUND

The present invention generally relates to computer systems, and more specifically, to computer-implemented methods, computer systems, and computer program products configured and arranged to provide automated single-to-grouped cloud computing optimization and infrastructure recommendations.

Cloud computing is the on-demand availability of computer system resources, especially data storage also referred to as cloud storage and computing power, without direct active management by the user. Large clouds often have functions distributed over multiple locations, each of which is a data center. Cloud computing relies on sharing of resources to achieve coherence.

A consumer can unilaterally provision computing capabilities, such as server time and network storage, as needed automatically without requiring human interaction with each service provider. Capabilities are available over the network and accessed through standard mechanisms that promote use by heterogeneous thin or thick client platforms such as mobile phones, tablets, laptops, and workstations. In some cases, the computing resources are pooled to serve multiple consumers using a multi-tenant model, with different physical and virtual resources dynamically assigned and reassigned according to consumer demand. Capabilities can be elastically provisioned and released, in some cases automatically, to scale rapidly outward and inward commensurate with demand. To the consumer, the capabilities available for provisioning often appear unlimited and can be appropriated in any quantity at any time.

### SUMMARY

Embodiments of the present invention are directed to computer-implemented methods for providing automated single-to-grouped cloud computing optimization and infrastructure recommendations. A non-limiting computer-implemented method includes generating, by a first machine learning model, a single notification for a computing environment, and in response to receiving user responses to a string of the single notification and other single notifications for the computing environment, determining to switch from a single mode to a group mode. The method includes based on the user responses to the string of the single notification and the other single notifications for the computing environment, generating, by a second machine learning model, a group of notifications for the computing environment. The method includes causing at least one modification to the computing environment in accordance with at least one affirmative user response to the group of notifications.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system configured to automatically provide automated single-to-grouped cloud computing optimization and infrastructure recommendations and to automatically execute modifications in the computing environment for the accepted recommendations according to one or more embodiments of the present invention;

FIG. 3 depicts a flowchart of a computer-implemented method for automatically providing automated single-to-grouped cloud computing optimization and infrastructure recommendations and automatically executing modifications in the computing environment for the accepted recommendations according to one or more embodiments of the present invention;

FIGS. 4A and 4B depict a flowchart of a computer-implemented method for automatically providing automated single-to-grouped cloud computing optimization and infrastructure recommendations and automatically executing modifications in the computing environment for the accepted recommendations according to one or more embodiments of the present invention;

FIG. 5 depicts an example block diagram for displaying a top single recommendation using a single recommendation machine learning model according to one or more embodiments of the present invention;

FIG. 6 depicts an example block diagram for displaying a recommendation dependency graph for all the resources according to one or more embodiments of the present invention;

FIG. 7 depicts an example block diagram for generating overlapping similarity clusters using a recommendation and user clustering machine learning model according to one or more embodiments of the present invention;

FIG. 8 depicts an example block diagram for a hot streak orchestrator according to one or more embodiments of the present invention;

FIG. 9 depicts an example block diagram for outputting ranked grouped recommendations according to one or more embodiments of the present invention;

FIG. 10 depicts an example block diagram for determining recommendation to recommendation similarity according to one or more embodiments of the present invention;

FIG. 11 depicts an example block diagram for determining user to user similarity according to one or more embodiments of the present invention;

FIG. 12 depicts an example of different types of assets/resources to be tracked in a computing environment according to one or more embodiments of the present invention;

FIG. 13 depicts an example findings/recommendations with a resource identification (ID) for the computer asset/resource and its corresponding recommendation according to one or more embodiments of the present invention;

FIG. 14 depicts a flowchart of a computer-implemented method for automatically providing automated single-to-grouped cloud computing optimization and infrastructure recommendations and automatically executing modifications in the computing environment for the accepted recommendations according to one or more embodiments of the present invention;

FIG. 15 depicts a cloud computing environment according to one or more embodiments of the present invention; and

FIG. 16 depicts abstraction model layers according to one or more embodiments of the present invention.

### DETAILED DESCRIPTION

One or more embodiments automatically provide automated single-to-grouped cloud computing optimization and infrastructure recommendations and automatically execute modifications in the computing environment for the accepted recommendations. The cloud computing environment is a computing environment, and an automated resolution/change system is configured to execute the modifications in the computing environment, thereby preventing cybersecurity issues or threats in the computing environment. Further, the accepted recommendations improve security and increase performance for the operations of the user which utilize the software and hardware components in the cloud computing environment. The automated resolution/change system can use a resource identification (ID) along with the corresponding recommendation, and the recommendation can be to delete a resource (e.g., software, a virtual machine, etc.), repurpose a resource (e.g., software, a virtual machine, etc.), shut down a resource (e.g., software, hardware (e.g., storage resource), etc.), enable auto scaling, etc. The resource identification (ID) identifies a particular asset/resource in the cloud computing environment that is to be changed.

Cloud computing management is difficult and an organization (e.g., user) can have over one-hundred thousand computer resources/assets, and there can be thousands of ways to improve the infrastructure and reduce the number of resources utilized. It may be difficult to encourage a user to take his/her first action because the user may not fully understand what to do. One or more embodiments provide a recommender system that allows users to be gradually introduced to recommendations, for example, “dip their toes” in recommendations by outputting the recommendations for display one by one, and once the user becomes more comfortable, the recommender system enables the users to take mass action in “hot streak” interactions. For example, when a user has three-hundred thousand or more assets/resources, the recommender system makes recommendations more digestible and provides a way to get the user started on taking recommendations; then, the recommender system displays more recommendations and groups of recommendations that are relevant to the user's interests based on what recommendations he/she has already accepted in the past, thereby utilizing real-time feedback from the user as reinforcement learning for various machine learning models discussed herein. This helps to bring together recommendations that are related to ones that the user has taken in the past. This assists the user with managing their existing resources in the cloud computing environment.

As technical benefits, solutions, and/or effects, one or more embodiments provide recommendation models/engines that generate a single recommendation object or a grouped list of recommendation objects based on the current state of the recommender system. The grouped recommendations are initiated or triggered during “hot streak” interactions. The recommender system uses reinforcement learning to determine actions, penalties, and rewards for the machine learning models. One or more embodiments reinvent insight recommendations for the user by maximizing the cost saving of computer resource utilization (e.g., utilizing fewer computer resources to accomplish tasks) with personalized and explainable recommendations.

One or more embodiments described herein can utilize machine learning techniques to perform tasks, such as classifying a feature of interest. More specifically, one or more embodiments described herein can incorporate and utilize rule-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

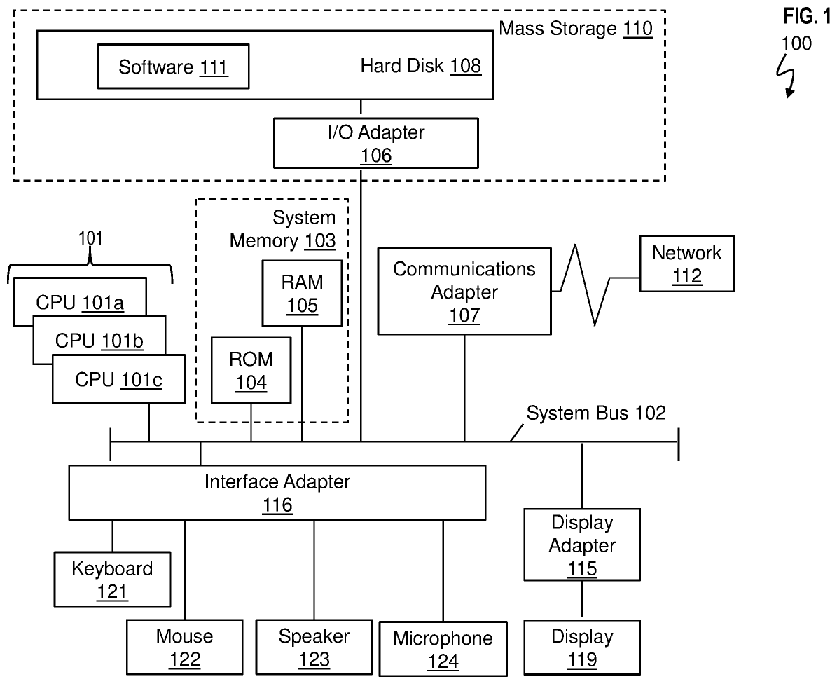

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

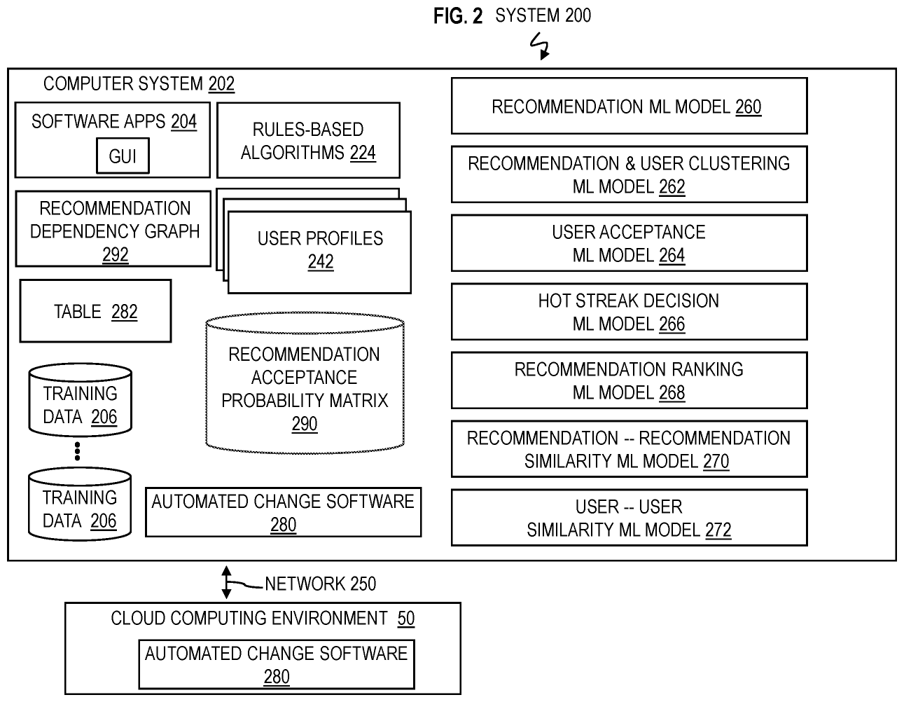

FIG. 2 depicts a block diagram of an example system 200 configured for automatically providing automated single-to-grouped cloud computing optimization and infrastructure recommendations and automatically executing computer modifications in the computing environment for the accepted recommendations according to one or more embodiments. This improves the resources, such as software components and hardware components, being utilized in the computing environment. The system 200 includes a computer system 202 configured to communicate over a network 250 with a cloud computing environment 50. The computer system 202 may be considered a recommender system or recommender explorer. The network 250 can be a wired and/or wireless communication network. In one or more embodiments, the computer system 202 may be part of the cloud computing environment 50. In one or more embodiments, a user can have a user device that interacts with the computer system 202. Further example details of the cloud computing environment 50 are discussed herein.

The computer system 202 including its software and hardware can include functionality and features of the computer system 100 in FIG. 1 including various hardware components and various software applications such as software 111 that can be executed as instructions on one or more processors 101 in order to perform actions according to one or more embodiments of the invention. The software application 204 can include, be integrated with, and/or call various other pieces of software, algorithms, application programming interfaces (APIs), etc., to operate as discussed herein. The software applications 204 can work with, call, interface with, and/or operate any of the machine learning models discussed herein. The software applications 204 may be representative of numerous software applications designed to work together. Each of the users of the computer system 202 have registered with registration and authentication software for a user account in order to utilize the services provided by computer system 202 along with cloud computing environment 50, and each of the users has its own user account in its own user profile in user profiles 242. Each user profile may record recommendations provided to its user and user actions taken for each single recommendation and each group of recommendations by the user. The user profile 242 stores or records all information associated with the user for the recommender system.

The computer system 202 may be representative of numerous computer systems and/or distributed computer systems configured to provide automated single recommendation and/or grouped recommendations for cloud computing optimization and automatically execute modifications in the cloud computing environment 50 based on the accepted recommendations. As noted herein, the computer system 202 can be part of a cloud computing environment such as the cloud computing environment 50.

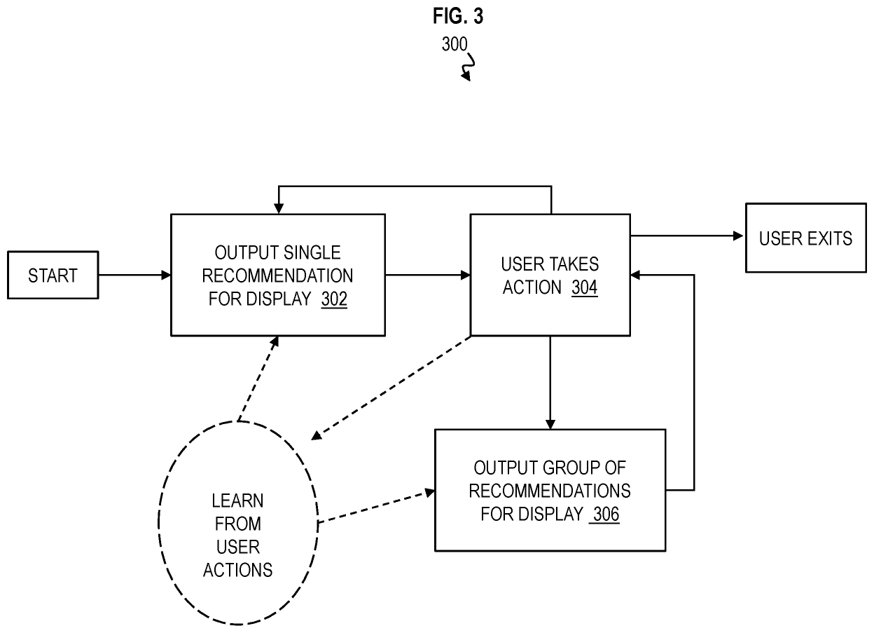

FIG. 3 is a flowchart of a computer-implemented method 300 for automatically providing automated single-to-grouped cloud computing optimization and infrastructure recommendations and for automatically executing modifications in the computing environment for the accepted recommendations. The computer-implemented method 300 can be executed by the computer system 202 and is illustrated as a high-level view.

The computer-implemented method 300 is a process for recommendation explorer. The computer-implemented method 300 enables a user to initiate/start taking actions for recommendations. The computer-implemented method 300 displays on display 119 to the user one recommendation to explore. Then, as the computer-implemented method 300 learns the user's behavior through reinforcement learning, the computer-implemented method 300 recommends and displays other single recommendations or a group of recommendations to take mass action. Reference can be made to any figures discussed herein.

Using a graphical user interface (GUI) of the software applications 204, the software applications 204 start a single recommendation machine learning (ML) model 260 in response to user input. The software applications 204 can include, employ, and/or call the GUI. The term user can be representative of an organization, company, etc. It is noted the computer system 202 ingests configuration items (CI) from the cloud computing environment 50 associated with the user. Configuration items are the fundamental structural unit of a configuration management system. Cloud management is the control and oversight of an organization's infrastructure, services, and applications that run in the cloud computing environment. The integrated configuration items delineating the computer resources can be ingested by the software applications 204 and provided to various machine learning models in order for the machine learning models to operate as discussed herein.

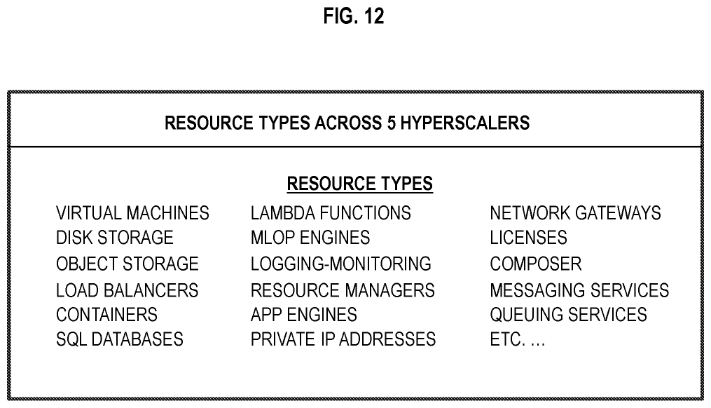

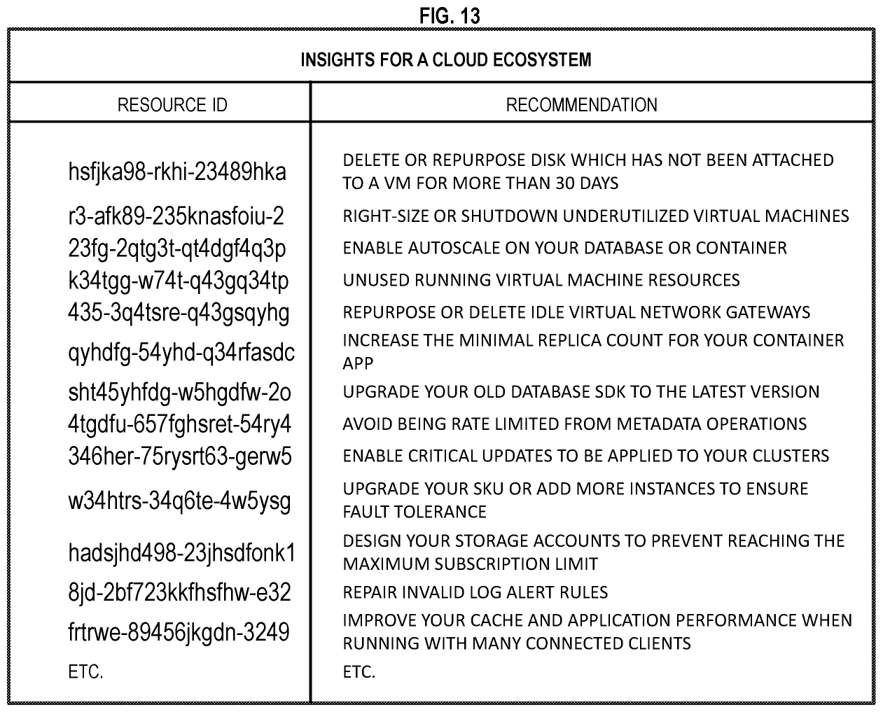

Turning to FIG. 3, at block 302 of the computer-implemented method 300, one or more software applications 204 of computer system 202 are configured to operate a (single) recommendation machine learning (ML) model 260 to display (e.g., on display 119) a single recommendation to the user. The recommendation is a finding that includes a recommendation and resource identification (ID) to which the recommendation applies. Example resource types are illustrated in FIG. 12. FIG. 12 depicts an example of the different types of assets/resources that a user may be responsible for keeping track of in the cloud computing environment 50. Example findings/recommendations are illustrated in FIG. 13 with a resource ID for the computer asset/resource and its corresponding recommendation. Example computer resources or configuration items include hardware/devices, software/applications, communications/networks, system, location, facility, databases, and/or services. Although the computer system 202 is configured to provide thousands of finding/recommendations to a user, it should be appreciated that only a few suggestions are illustrated in FIG. 13.

At block 304, one or more software applications 204 of computer system 202 are configured to receive user actions for the corresponding single recommendation (block 302) or the corresponding group of recommendations (block 306). The software applications 204 may generate selectable options for display including, for example, a dismiss button, a postpone button, and an accept button. The software applications 204 record (i.e., store) in a table 282 the selected user response to the single recommendation or group of recommendations, where the user response can be accept, dismiss, or postpone. Postponing a recommendation or group of recommendations is neither dismissing nor accepting the recommendations but could be viewed as slightly negative feedback to the machine learning models for the purposes of real-time training such as reinforcement learning.

The software applications 204 continue to operate the (single) recommendation ML model 260 to display another single recommendation (e.g., as a finding) to the user based on previous user responses, and then record the user response to the corresponding single recommendation.

At block 306, after a condition is met (e.g., a predetermined number of actions accepting and/or postponing single recommendations (in a row)) and/or after a determination is made (e.g., by a hot streak decision ML model 266), the software applications 204 are configured to operate a recommendation ranking ML model 268 to output for display (e.g., on display 119) a group of recommendations (or group of findings) at one time to the user. The group of recommendations is based on the current state of recommender system such as the particular type of recommendations previously provided to the user (e.g., for storage systems, virtual machines, forward facing software, etc.) and the corresponding user responses to the single recommendations and the grouped recommendations (when previous group recommendations have been displayed to the user). Moreover, the current state of the of recommender system is based on the preferences that the user has exhibited in the past and the user actions that the user has taken on recommendations that have been already displayed to them, all of which can be saved in the table 282 and/or the user profile 242. The grouped recommendations are initiated during hot streak interactions, and the hot streak decision ML model 266 uses reinforcement learning to determine actions, penalties, and rewards according to the specific user action times such as accept, dismiss, postpone for a given single recommendation and/or a given group of recommendations. After receiving the group of recommendations, the software applications 204 may generate selectable options for display including a dismiss button, a postpone button, and an accept button. The software applications 204 record the selected user response to the group of recommendations, where the user response can be accept, dismiss, or postpone. If the user response is to dismiss the group of recommendations during the hot streak, then the (recommender) computer system 202 resorts back to providing a single recommendation at a time. If the user response is to accept the group of recommendations during the hot streak, the recommender computer system 202 continues providing the subsequent output as a group of recommendations. The user can exit the GUI of the software applications 204 as desired. Each of the machine learning models discussed herein learns from the user actions of accept, postpone, and dismiss for each corresponding single recommendation and corresponding groups of recommendations.

For the recommendations accepted, including both single recommendations or groups of recommendations, the software applications 204 are configured to cause modifications/changes in or associated with the accepted recommendations to be automatically executed in the cloud computing environment 50. In one or more embodiments, the software applications 204 can call, employ, and/or be integrated with automated resolution/change software 280 configured to execute changes for the accepted recommendations in the cloud computing environment 50.

The automated resolution/change software 280 is configured to perform changes to computer resources in a cloud computing environment and/or an information technology (IT) environment. For example, one or more software components and/or hardware components in the cloud computing environment can be automatically changed by the automated resolution/change software 280 based on the accepted recommendations, thereby resulting in optimized software and/or hardware components of computer systems in the cloud computing environment.

In one or more embodiments, upon accepted recommendations being saved on the computer system 202, software applications 204 can generate tickets and/or send the accepted recommendations to a ticketing system to be generated as tickets. The ticket can be sent to the automated resolution/change software 280 to be executed. A ticket is a special document or record that represents an incident, alert, change request, and/or event that requires action from the IT department. In one or more embodiments, the accepted recommendations can cause an IT professional to make a corresponding change to the software and/or hardware components in the cloud computing environment.

The software applications 204 uses each single recommendation and each group of recommendations to generate a recommendation acceptance probability matrix 290 for all recommendations and their associated user responses.

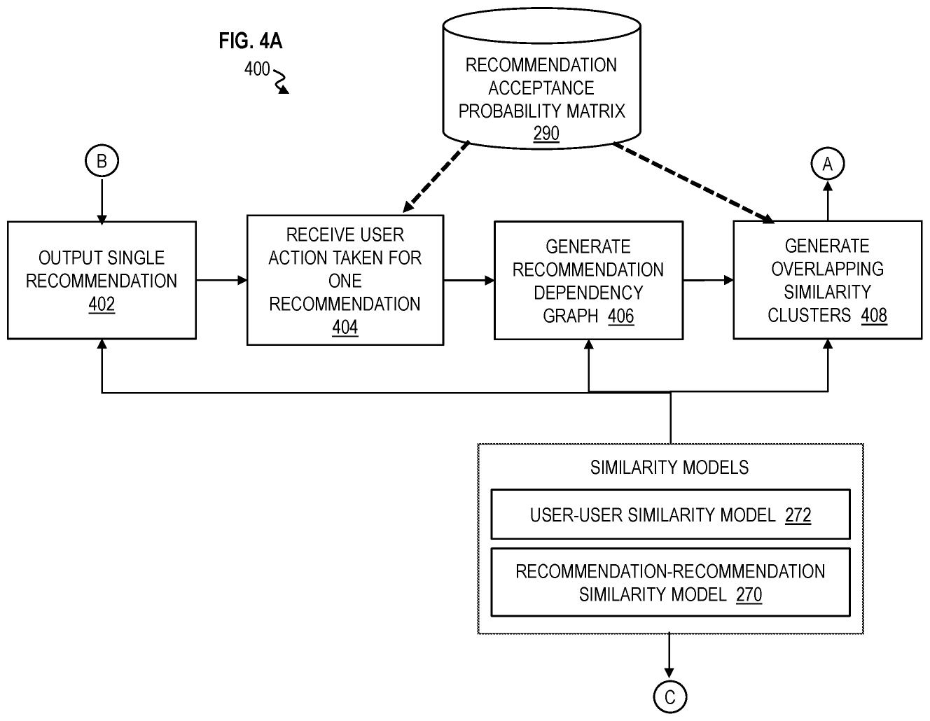

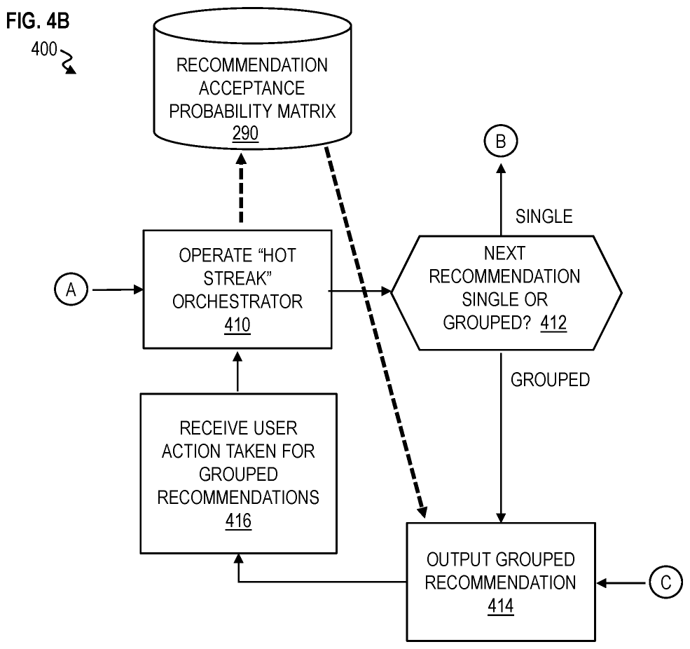

FIGS. 4A and 4B depict a flowchart of a computer-implemented method 400 as an overview for automatically providing automated single-to-grouped cloud computing optimization and infrastructure recommendations and for automatically executing modifications in the computing environment for the accepted recommendations. The computer-implemented method 400 can be executed by the computer system 202. Reference can be made to any figures discussed herein.

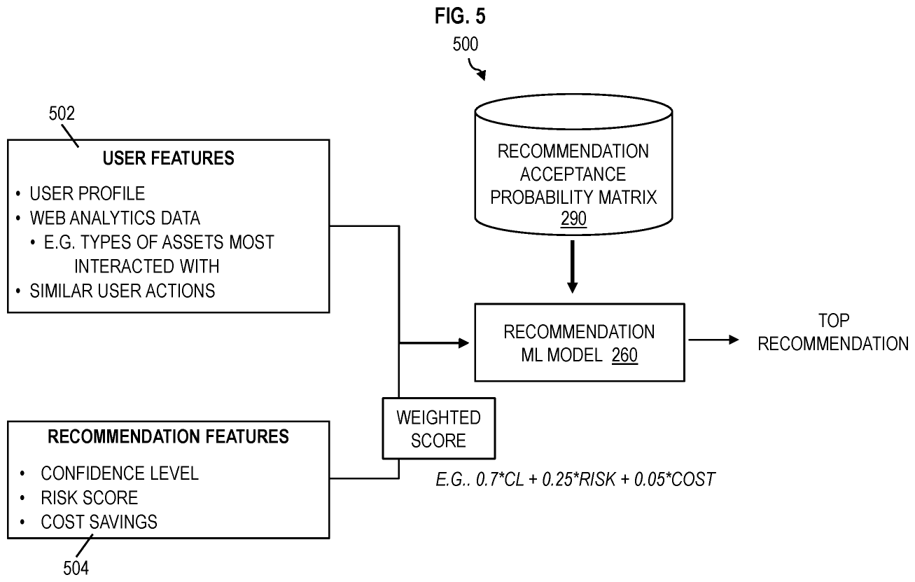

At block 402 of the computer-implemented method 400, the software applications 204 are configured to operate a (single) recommendation machine learning ML model 260 to display (e.g., on display 119) a single recommendation to the user. Further details regarding the recommendation machine learning ML model 260 are depicted in FIG. 5.

At block 404, the software applications 204 of computer system 202 are configured to receive user actions taken for the corresponding single recommendation. As noted herein, the software applications 204 may generate selectable options for display including a dismiss button, a postpone button, and an accept button.

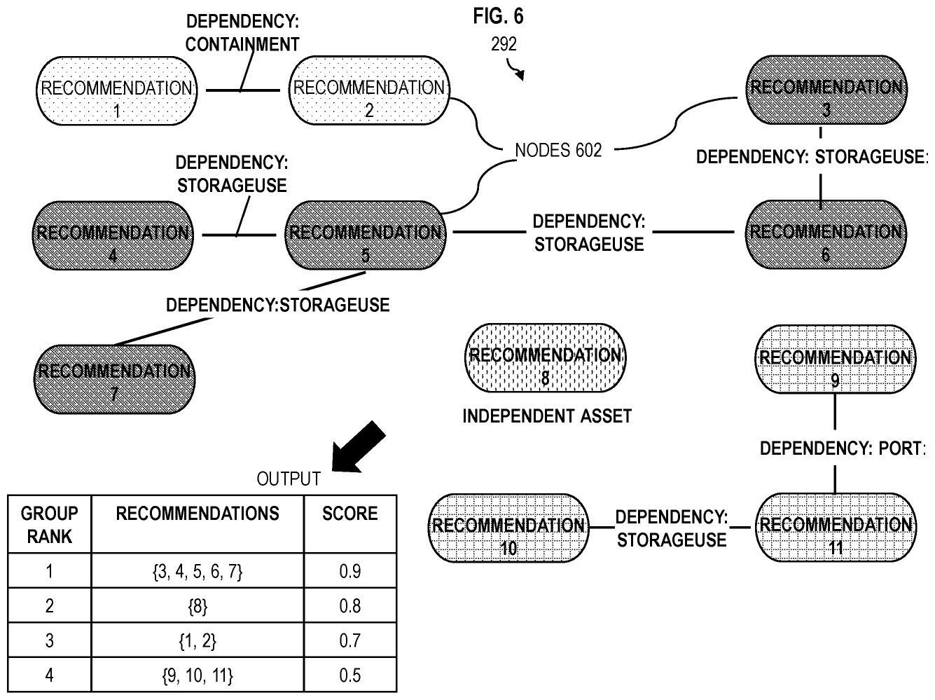

At block 406, the software applications 204 are configured to generate a recommendation dependency graph 292 (e.g., with further details depicted in FIG. 6) based on the recommendations. For example, the recommendation dependency graph 292 is based on how the recommendations interrelate to each other and how the computer resources of the recommendations are dependent upon other computer resources. The recommendation dependency graph 292 keeps track of the resource that the recommendation applies to and any other cloud resources that are related to or dependent on that resource. For example, if the resource is an object storage or elastic cloud compute (EC2) instance (e.g., virtual server), and if the EC2 instance depends on another instance or is related to the other instance, then it would not be a full picture for the user to only delete that suggested recommendation resource without the user knowing that the (potential) recommendation resource is dependent on other resources. Accordingly, the recommendation dependency graph 292 keeps track of dependencies on assets/resources so that the dependencies influence the subsequent recommendations that are to be shown to the user, which could be to modify a dependent resource.

At block 408, the software applications 204 are configured to operate a recommendation and user clustering ML model 262 to generate overlapping similarity clusters. The recommendation and user clustering ML model 262 outputs a series of overlapping clusters grouping users, clusters grouping resources, and clusters grouping recommendations. Based on using the recommendation dependency graph 292, the recommender computer system 202 generates overlapping similarity clusters using, for example, a recommendation to recommendation similarity ML model 270 and a user to user similarity ML model 272.

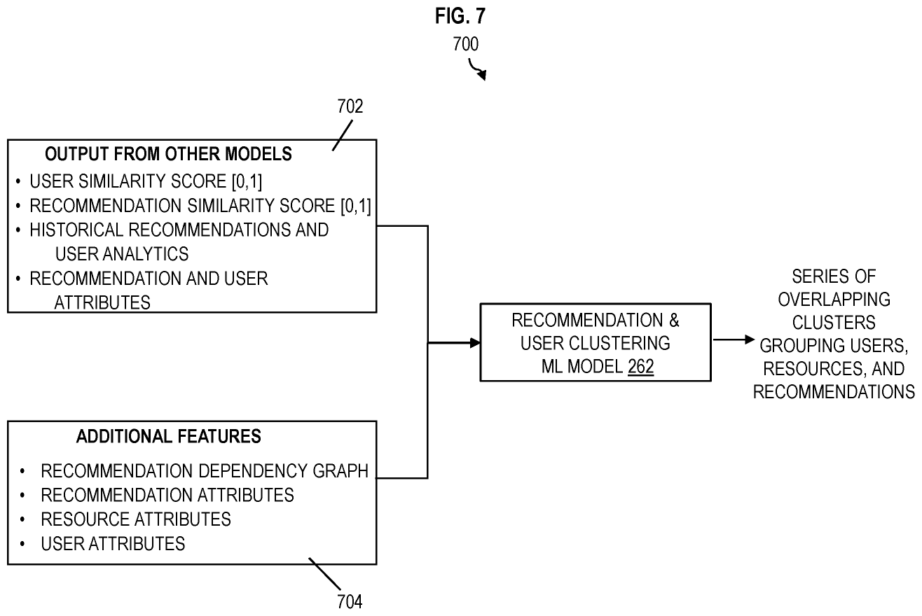

The recommendation to recommendation similarity ML model 270 and user to user similarity ML model 272 generate the clusters. For instance, each asset/resource might belong to multiple different clusters of recommendation, and so the clusters could overlap; for example, an asset/resource belongs to one cluster of recommendation and that cluster is more targeted towards deleting assets that are underutilized. Based on past user responses, this could be one cluster of recommendations that the user is interested in, and the recommender computer system 202 can output similar recommendations to the user from that one cluster as a group of recommendations. Further details regarding the recommendation and user clustering ML model 262 are depicted in FIG. 7.

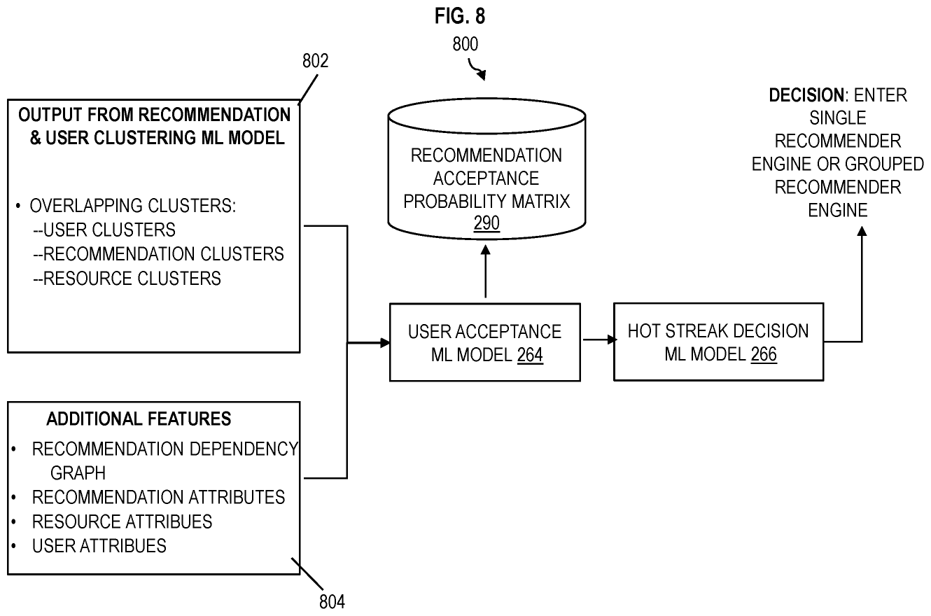

At block 410, the software applications 204 are configured to operate a hot streak decision ML model 266 to output a decision of operating a single recommender or operating a grouped recommender. The hot streak ML model 266 keeps track of whether the user is on a hot streak or not. For example, the user has accepted several recommendations in a row, then this would trigger the hot streak, and the recommender computer system 202 shows the user a group of recommendations. On the other hand, if the user has been dismissing recommendations and/or accepting only a few (e.g., sporadically), and if there does not seem to be any pattern or trend displaying a hot streak, then the hot streak ML model 266 continues to output single recommendations for display until a pattern is found. As such, the hot streak is not triggered. Further details of the hot streak orchestrator are illustrated in FIG. 8.

At block 412, the software applications 204 checks whether the hot streak decision ML model 266 determines that a single recommendation should be provided to the user or that a group of recommendations should be provided to the user. When the hot streak decision ML model 266 determines that a single recommendation is to be provided to the user, flow proceeds to block 402.

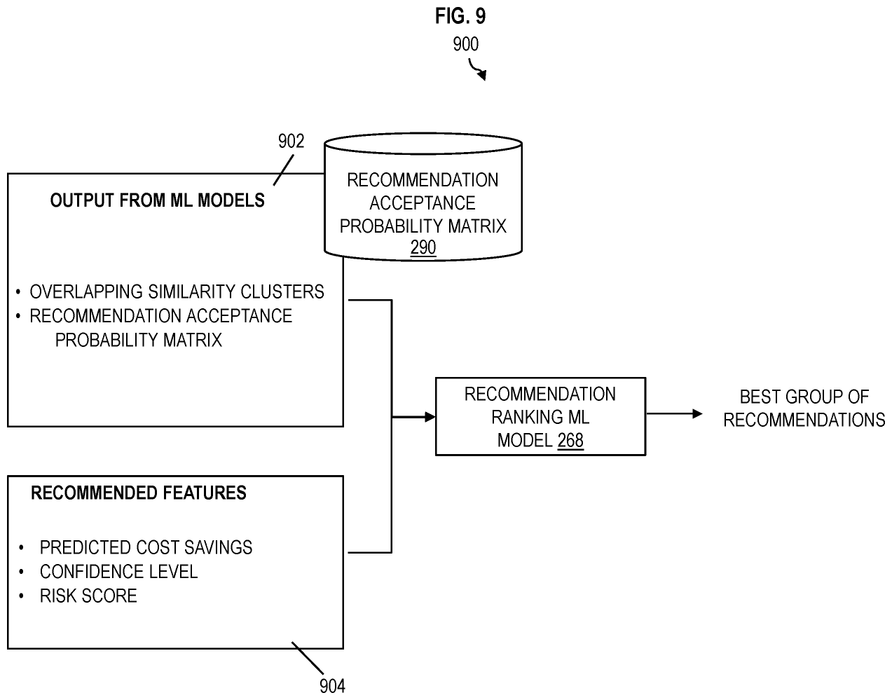

At block 414, when the hot streak decision ML model 266 determines that a group of recommendations is to be provided to the user, the software applications 204 are configured to operate a (group) recommendation ranking ML model 268 to output for display (e.g., on display 119) a group of recommendations (or findings) to the user. The group of recommendations is based the current state of recommender computer system 202 such as the particular type of recommendations previously provided to the user (e.g., for storage systems, virtual machines, etc.) and the corresponding record of the user responses to single recommendations and the group of recommendations (e.g., stored in the table 282 and/or user profile 242). The recommendation ranking ML model 268 is configured to rank clusters (i.e., groups) of recommendations and output the highest ranked cluster/group of recommendations to the user. The recommendation ranking ML model 268 receives input of the clusters of recommendations from the similarity models which include the recommendation to recommendation similarity ML model 270 and the user to user similarity ML model 272. Further details regarding the recommendation ranking ML model 268 are illustrated in FIG. 9. After receiving the group of recommendations, the software applications 204 may generate selectable options for display including a dismiss button, a postpone button, and an accept button. At block 416, the software applications 204 receive and record the selected user response to the group of recommendations, where the user response, for example, can be accept, dismiss, or postpone.

As discussed herein, for the accepted single recommendations and the accepted groups of recommendations stored/recorded in, for example, the table 282 and/or the user profile 242, the software applications 204 are configured to cause modifications/changes in or associated with the accepted recommendations to be automatically executed in the cloud computing environment 50. In one or more embodiments, the software applications 204 can call, employ, and/or be integrated with the automated resolution/change software 280 that configured to execute changes for the accepted recommendations in the cloud computing environment 50.

The automated resolution/change software 280 is configured to perform changes to computer resources in a cloud computing environment and/or an information technology (IT) environment. For example, one or more software components and/or hardware components in the cloud computing environment can be automatically changed by an automated resolution/change software 280 based on the accepted recommendations, thereby resulting in optimized software and/or hardware components of computer systems in the cloud computing environment. The optimized software and/or hardware components protect against cybersecurity attacks, fix bugs/problems, improve the user facing interface (user experience (UX)), increase the efficiency of the operation of the software/hardware, etc., thereby providing an improved computer system. In one or more embodiments, upon accepted recommendations being saved on the computer system 202, software applications 204 can generate tickets and/or send the accepted recommendations to a ticketing system to be generated as tickets. In one or more embodiments, the accepted recommendations can cause an IT professional to make a corresponding change to the software and/or hardware components in the cloud computing environment.

Further details of the graph and models discussed herein are provided in FIGS. 5-11.

FIG. 5 depicts a block diagram 500 for display of a top single recommendation using the (single) recommendation ML model 260 according to one or more embodiments. The recommendation ML model 260 outputs the single most important and relevant recommendation to the user. There can be many different users that are representative of, for example, companies, organizations, schools, government entities, etc.

The recommendation ML model 260 is initially trained on, uses, and is updated with (as part of reinforcement learning) user features 502 and recommendation features 504, along with the recommendation acceptance probability matrix 290. In one or more embodiments, portions of this data can be provided to the recommendation ML model 260 as feature sets or datasets. Additionally, the recommendation ML model 260 is fed the configuration items of the cloud computing environment 50 for the user.

During the training phase, the user features 502, recommendation features 504, and the recommendation acceptance probability matrix 290 are utilized as training data to train the recommendation ML model 260 to output the single top recommendation for improving the cloud computing environment 50 of the user. The user features 502 for the user can include the user profile 242 of the particular user (e.g., organization), web analytics associated with software being run in the cloud computing environment 50 for the user (e.g., types of assets most interacted with), and similar user actions (e.g., data regarding the ither organizations have taken similar actions for the same type of recommendation). The recommendation features 504 can include the confidence level (CL), risk score (Risk), and cost savings (Cost). In one or more embodiments, the recommendation features 504 may be provided to the recommendation ML model 260 as a weighted score such as, for example, 0.7 (CL)+0.25 (Risk)+0.05 (Cost). The recommendation ML model 260 can rank all the scores. The training results in a trained (single) recommendation ML model 260 that displays the single most important and relevant recommendation to the user out of all the possible recommendations that are available.

As continual updating to the recommendation ML model 260 as well as the recommendation ranking ML model 268 after being deployed, reinforcement learning occurs by the recommendation acceptance probability matrix 290 repeatedly receiving user actions (e.g., dismiss, postpone, or accept) to recommendations and the user acceptance ML model 264 calculating the probability of the user accepting a future recommendation based on past actions of the user for given recommendations; these updates are continuously provided to the recommendation ML model 260, as reinforcement learning where, for example, the acceptance of a recommendation functions as a reward (e.g., positive) to the recommendation ML model 260 (as well as the recommendation ranking ML model 268), the dismissal of a recommendation functions as a penalty (e.g., negative), and the postponement of a recommendation can function as neutral value or slightly negative value (e.g., less negative than a dismissal).

The recommendation acceptance probability matrix 290 has clusters of recommendations, where the cluster is usually two or more recommendations. In some cases, there can be a cluster with one recommendation, which means that the recommendation acceptance probability matrix 290 has an acceptance probability by the user for each single recommendation and each group of recommendations. The clusters of recommendations in the recommendation acceptance probability matrix 290 are ranked by their likelihood of being accepted by the user. This ranking for the clusters/groups of recommendations is primarily driving the recommendation ranking ML model 268, along with the weighted score of the confidence level risk score, and cost savings to the user.

FIG. 6 depicts a block diagram for display of the recommendation dependency graph 292 for all the resources according to one or more embodiments. The recommendation dependency graph 292 stores and tracks the dependency between assets/resources, the relationship between recommendations, and the relationship between assets/resources and recommendations. The software applications 204 can call, include, and/or employ tracking software or management software to track the configuration items (including resources) of the cloud computing environment 50 for the user.

Each recommendation is attached to its resource(s)/asset(s). The recommendation dependency graph 292 displays single recommendations as nodes 602 connected by edges to other nodes 602 in the same group of recommendations. The recommendation dependency graph 292 groups a single recommendation to another single recommendation by an edge that denotes the resource dependency relationship between the nodes. For instance, an example group of recommendations includes recommendation 1 and recommendation 2 connected by the edge dependency: containment. Another example group of recommendations includes recommendation 9, recommendation 10, and recommendation 11, where recommendation 9 is connected to recommendation 11 by the edge dependency: port, and where recommendation 11 is connected to recommendation 10 by edge dependency: storage use.

The output from the recommendation dependency graph 292 can be group rank, identification of the recommendations, and a score. For example, the top entry has a group rank 1, the group includes recommendations 3, 4, 5, 6, and 7, and the score is 0.9.

FIG. 7 depicts a block diagram 700 for generation of overlapping similarity clusters using the recommendation and user clustering ML model 262 according to one or more embodiments. The recommendation and user clustering ML model 262 outputs a series of overlapping clusters grouping users (e.g., different organizations using the recommender system), grouping resources, and grouping recommendations.

The recommendation and user clustering ML model 262 is initially trained on, uses, and is updated with (as part of reinforcement learning) a block 702 having output from other models and additional features 704. During the training phase, the block 702 of output from other models and the additional features 704 are utilized to train the recommendation and user clustering ML model 262 to output the series of overlapping clusters grouping users, grouping resources, and grouping recommendations for the cloud computing environment 50 of the user.

The block 702 of output from other models can include a user similarity score [0,1], a recommendation similarity score [0,1], historical recommendations and user analytics, and recommendation and user attributes. The additional features 704 can include the recommendation dependency graph 292, recommendation attributes, resource attributes, and user attributes. As one similarity model, the recommendation to recommendation similarity ML model 270 outputs a score of how similar a recommendation (and/or group of recommendations) is to another recommendation (and/or group of recommendations). As another similarity model, the user to user similarity ML model 272 outputs a score of how similar a user (e.g., an organization) is to another user (e.g., another organization). The historical recommendations and user analytics refer to past actions that the user has taken for past recommendations. The recommendation and user attributes refer to the features of each recommendation and the features of the user. User attributes may include the web analytics of the user, for example, the industry of the user/company, the company size, the region, demographic information, etc., along with any other information in the user profile 242.

As a result, the trained recommendation and user clustering ML model 262 generates a series of combinations/clusters: (1) clusters of resources and recommendations grouped by dependency, (2) clusters of resources and recommendations grouped by similarity profiles, (3) clusters of recommendations grouped by similar past actions from the user profiles 242, and (4) clusters of user profiles 242 grouped based on attributes, past actions, departments, etc. All of the clusters generated by the recommendation and user clustering ML model 262 are stored in the table 282 in memory of the computer system 202 and/or other memory coupled to the computer system 202.

FIG. 8 depicts a block diagram 800 for a hot streak orchestrator according to one or more embodiments. The hot streak orchestrator includes the user acceptance model ML model 264 and the hot streak decision ML model 266. The hot streak orchestrator represents a two-fold model that (1) takes user actions and determines the next recommender engine/model (e.g., (single) recommendation ML model 260 or (group) recommendation ranking ML model 268) and (2) publishes recommendation acceptance probabilities in the recommendation acceptance probability matrix 290 to be ingested by recommender engines/models.

The user acceptance model ML model 264 is initially trained on, uses, and is updated with (as part of reinforcement learning) block 802 having output from recommendation and user clustering ML model 262 and additional features 804. From block 802, the user acceptance model ML model 264 receives overlapping clusters including: user clusters grouped based on information in user profiles 242, recommendation clusters grouped by similar past actions from the user profiles 242, resource clusters grouped by grouped by similarity profiles, etc. The additional features 804 can include the recommendation dependency graph 292, recommendation attributes, resource attributes, and user attributes. During the training phase, the block 802 and additional features 804 are utilized to train the user acceptance model ML model 264 to (1) output a prediction/likelihood of user acceptance per single recommendation and/or per group of recommendations, and (2) output recommendation acceptance probabilities per single recommendation and user cluster, which are provided to the recommendation acceptance probability matrix 290. The user acceptance model ML model 264 can include a Bayesian inference model based on historical actions.

Additionally, during the training phase, the hot streak decision ML model 266 is initially trained on, uses, and is updated with (as part of reinforcement learning) the prediction/likelihood of user acceptance per single recommendation and/or per group of recommendations from the user acceptance model ML model 264. The hot streak decision ML model 266 is configured to: (1) output a decision of utilizing a single recommender engine (e.g., (single) recommendation ML model 260) or grouped recommender engine (e.g., (grouped) recommendation ranking ML model 268), (2) discontinue utilizing grouped recommender engine (e.g., (grouped) recommendation ranking ML model 268) when a minimum threshold for user acceptance is not met, and (3) recalculate the minimum threshold for user acceptance over time based on the distribution of historical user actions. Based on the decision by the hot streak decision ML model 266, the (single) recommendation ML model 260 is continued or the (grouped) recommendation ranking ML model 268 is triggered. In some cases, the recommendation ranking ML model 268 has been previously triggered, and the hot streak decision ML model 266 can continue deciding to operate the hot streak decision ML model 266.

FIG. 9 depicts a block diagram 900 for outputting ranked grouped recommendations according to one or more embodiments. When a hot streak is triggered/determined, the (grouped) recommendation ranking ML model 268 is configured to output a display of the group of recommendations that the user is likely to accept based on past user interactions with previously displayed recommendations.

The recommendation ranking ML model 268 is initially trained on, uses, and is updated with (as part of reinforcement learning) block 902 having output from other ML models which include overlapping similarity clusters and the recommendation acceptance probability matrix 290 and recommended features 904. The recommended features 904 can include predicted cost savings, confidence level, and risk score. During the training phase, the block 902 and the recommended features 904 are utilized to train the recommendation ranking ML model 268 to output for display the best group of recommendations such as, for example, the group/cluster ranked 1 with the group/cluster of recommendations 3, 4, 5, 6, and 7 depicted in FIG. 6. Further, the recommendation ranking ML model 268 generates a score for each of the groups of recommendations, such as 0.9 for the top ranked group of recommendations in FIG. 6, and then displays the highest scoring group of recommendations as the best group of recommendations.

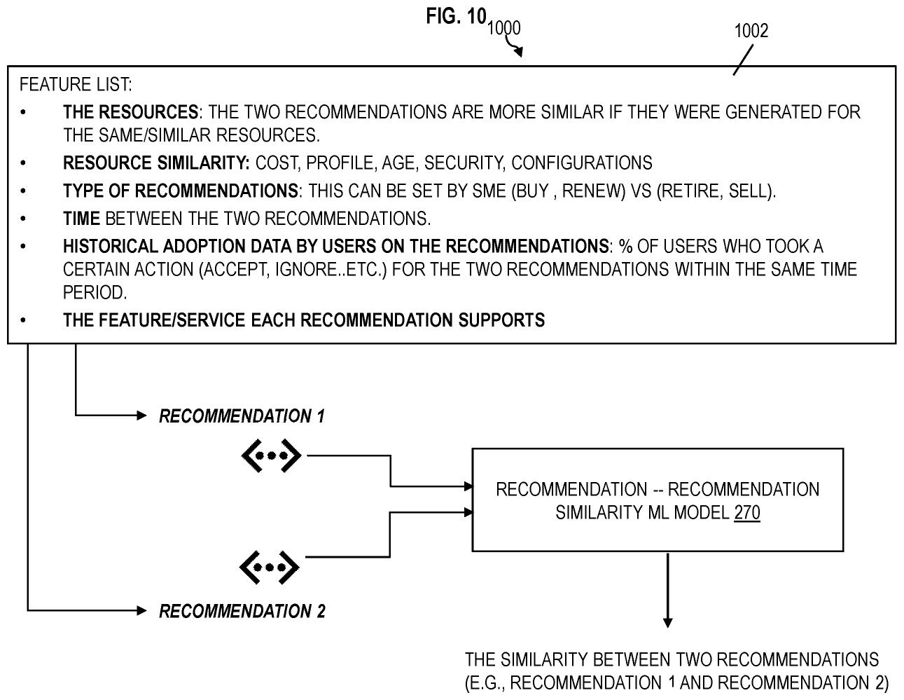

FIG. 10 depicts a block diagram 1000 for determining recommendation to recommendation (recommendation—recommendation) similarity according to one or more embodiments. The recommendation to recommendation similarity ML model 270 is configured to output the similarity (as a value) between two (given) recommendations ranging from [0, 1], where 0 is no similarity (e.g., 0% similar), 1 is completely similar (e.g., 100% similar), and/or some value between 0 and 1. This similarity comparison is performed such that each recommendation is compared to every other recommendation in order to output a recommendation to recommendation similarity score for all possible pairs.

The recommendation to recommendation similarity ML model 270 is initially trained on, uses, and is updated with (as part of reinforcement learning) a feature list 1002. The feature list 1002 for the two given recommendations being compared can include the resources (e.g., the two recommendations are more similar if they were generated from the same/similar resources), the resource similarity (e.g., cost, profile, age, security, configurations, etc., for the given recommendations), type of recommendations (e.g., this can be set by the subject matter experts (SME), such as buy or renew versus retire or sell), time (e.g., the time between the points at which the two recommendations were displayed to the user), historical adoption data by users of the recommendations (e.g., percent % of users who took the same action (e.g., accept, ignore, postpone) for the (same) two recommendations within the same time period), and/or the feature/service that each recommendation supports. During the training phase, the two given recommendations and their feature list 1002 are utilized to train recommendation to recommendation similarity ML model 270 to output the similarity (e.g., a value ranging from [0,1]) between the two recommendations (e.g., between recommendation 1 and recommendation 2). As noted herein, this similarity score is calculated between every recommendation.

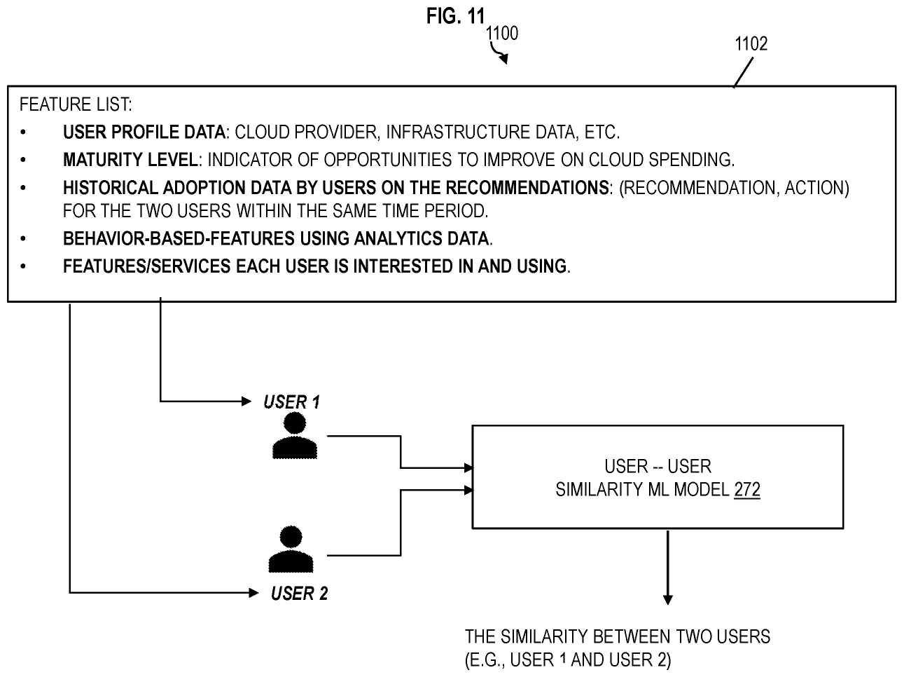

FIG. 11 depicts a block diagram 1100 for determining user to user to user (user—user) similarity according to one or more embodiments. The user to user similarity ML model 272 is configured to output the similarity (e.g., as a value) between two (given) users ranging from [0, 1], where 0 is no similarity (e.g., 0% similar), 1 is completely similar (e.g., 100% similar), and/or some value between 0 and 1. This similarity comparison is performed such that each user (who has its own user profile 242) is to compared to every other user in order to output a user to user similarity score for all possible pairs.

The user to user similarity ML model 272 is initially trained on, uses, and is updated with (as part of reinforcement learning) a feature list 1102. The feature list 1102 for the two given users being compared can include user profile data (e.g., cloud provider, infrastructure data, region of the country, etc.), maturity level (e.g., usage of cloud including, e.g., crawl (e.g., low usage), walk (e.g., medium usage), run (high usage) which can serve as an indicator of opportunities to improve on cloud spending/usage), historical adoption data by users on the recommendations ((e.g., recommendation and action) for the two users within the same time period), behavior-based-features using analytics data for tracking the user's interaction with the recommender platform, and/or features/services each user is interested in and using. During the training phase, the two given users and their feature list 1102 are utilized to train the user to user similarity ML model 272 to output the similarity (e.g., a value ranging from [0,1]) between the two users (e.g., between user 1 and user 2).

The recommendation to recommendation similarity ML model 270 and the user to user similarity ML model 272 provide input to the recommendation and user clustering ML model 262 for clustering features together.

In one or more embodiments, a machine learning model may be augmented with, integrated with, and/or replaced with rules-based algorithms 224. An example of a rules-based system is a domain-specific expert system that uses rules to make deductions or choices. The rules-based system includes a set of facts or source of data related to capturing objects, and a set of rules for manipulating that data. These rules are sometimes referred to as “If statements” as they tend to follow the line of “IF X happens THEN do Y.”

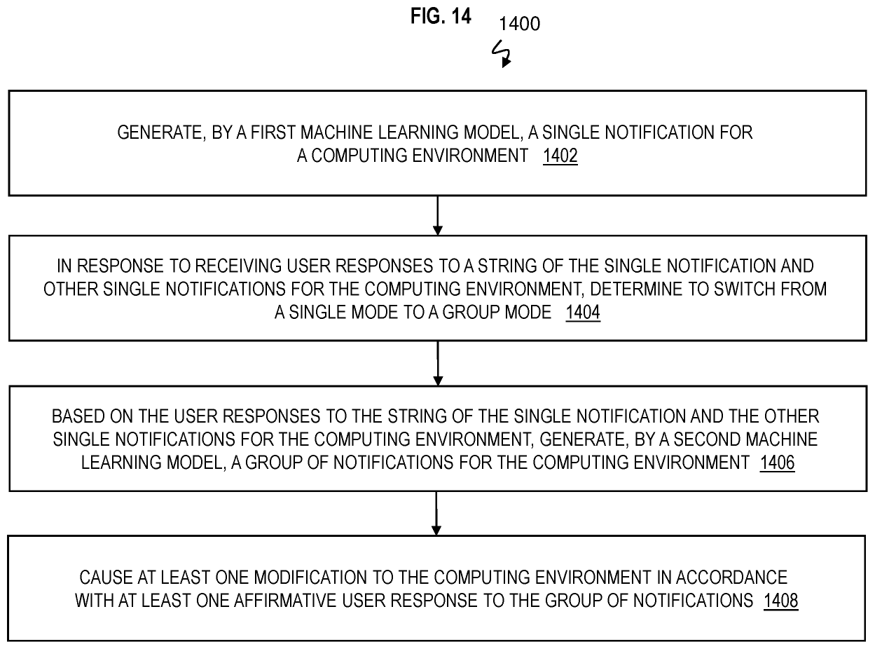

FIG. 14 is a flowchart of a computer-implemented method 1400 for automatically providing/displaying automated single-to-grouped cloud computing optimization and infrastructure recommendations and automatically executing computer modifications in the computing environment for the accepted recommendations according to one or more embodiments. The computer-implemented method 1400 can be executed by computer system 202 and/or any computer system coupled to computer system 202. Reference can be made to any figures discussed herein.

At block 1402, the computer-implemented method 1400 includes generating, by a first machine learning model (e.g., (single) recommendation ML model 260), a single notification (e.g., single recommendation) for a computing environment (e.g., cloud computing environment 50). At block 1404, the computer-implemented method 1400 includes, in response to receiving user responses to a string of the single notification (e.g., the single recommendation) and other single notifications (e.g., other single recommendations) for the computing environment, determining to switch from a single mode to a group mode. For example, the hot streak decision ML model 266 is configured to switch from causing a single recommendation to be output as the single mode to causing a group of recommendations to be output as the group mode. At block 1406, the computer-implemented method 1400 includes, based on the user responses to the string of the single notification and the other single notifications for the computing environment, generating, by a second machine learning model (e.g., the (group) recommendation ranking ML model 268), a group of notifications (e.g., a group of recommendations) for the computing environment (e.g., cloud computing environment 50). At block 1408, the computer-implemented method 1400 includes causing at least one modification to the computing environment in accordance with at least one affirmative user response to the group of notifications. The automated resolution/change software 280 is configured to change software components and/or hardware components (which are computer resources) in the cloud computing environment 50 based on the acceptance of the recommendation (e.g., single recommendation and/or group of recommendations).

In one or more embodiments, a third machine learning model (e.g., the hot streak decision ML model 266) determines the switch from the single mode to the group mode, for example, from outputting a single recommendation at a time to outputting a group of recommendations at a time. A third machine learning model (e.g., the hot streak decision ML model 266) determines to another switch from the group mode back to the single mode based on further user responses during the group mode. Generating the group of notifications for the computing environment includes: ranking groups of notifications for the computing environment and outputting a highest ranked group of notifications as the group of notifications, for example, as depicted in FIG. 6. Generating the group of notifications for the computing environment is based, at least in part, on the group of notifications having a highest likelihood of acceptance.

A fourth machine learning model (e.g., the user acceptance ML model 264) generates a recommendation acceptance probability matrix 290 including a probability of acceptance for each past single notification and each past group of notifications; the second machine learning model (e.g., the recommendation ranking ML model 268) generates the group of notifications for the computing environment based, at least in part, on the recommendation acceptance probability matrix. The at least one modification to the computing environment improves a functioning of at least one of a software resource or a hardware resource in the computing environment.

In one or more embodiments, the machine learning models discussed herein can include various engines/classifiers and/or can be implemented on a neural network. The features of the engines/classifiers can be implemented by configuring and arranging the computer system 202 to execute machine learning algorithms. In general, machine learning algorithms, in effect, extract features from received data (e.g., the complete message formed of segmented messages) in order to “classify” the received data. Examples of suitable classifiers include but are not limited to neural networks, support vector machines (SVMs), logistic regression, decision trees, hidden Markov Models (HMMs), random forests, K-nearest neighbors, gradient boosting, etc. The end result of the classifier's operations, i.e., the “classification,” is to predict a class (or label) for the data. Additional learning/training methods include, for example, clustering, anomaly detection, neural networks, deep learning, convolutional neural networks (CNNs), recurrent neural networks (RNNs), long short-term memory (LSTM) networks, transformer networks, gated recurrent units (GRUs), deep belief networks (DBNs), generative adversarial networks (GANs), and the like. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier.

In one or more embodiments, the engines/classifiers are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Training datasets (or training data 206 such as, e.g., various types of inputs to models including features, etc., discussed herein) can be utilized to train the machine learning algorithms. The training datasets can include historical data of past tickets and the corresponding options/suggestions/resolutions provided for the respective tickets. Labels of options/suggestions can be applied to respective tickets to train the machine learning algorithms, as part of supervised learning. For the preprocessing, the raw training datasets may be collected and sorted manually. The sorted dataset may be labeled (e.g., using the Amazon Web Services® (AWS®) labeling tool such as Amazon SageMaker® Ground Truth). The training dataset may be divided into training, testing, and validation datasets. Training and validation datasets are used for training and evaluation, while the testing dataset is used after training to test the machine learning model on an unseen dataset. The training dataset may be processed through different data augmentation techniques. Training takes the labeled datasets, base networks, loss functions, and hyperparameters, and once these are all created and compiled, the training of the neural network occurs to eventually result in the trained machine learning model (e.g., trained machine learning algorithms). Once the model is trained, the model (including the adjusted weights) is saved to a file for deployment and/or further testing on the test dataset.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

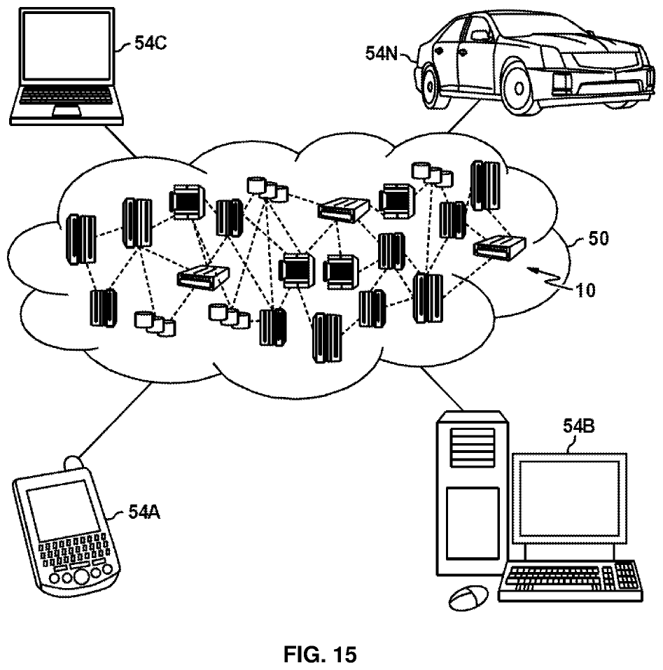

Referring now to FIG. 15, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 15 are intended to be illustrative only and that computing nodes 10 and cloud computing environment 50 can communicate with any type of computerized device over any type of network and/or network addressable connection (e.g., using a web browser).

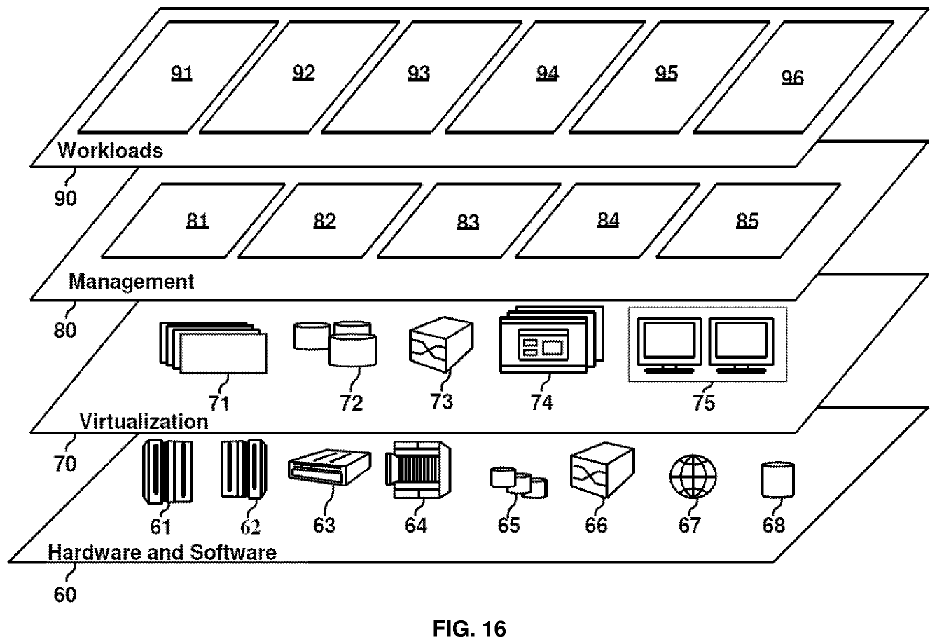

Referring now to FIG. 16, a set of functional abstraction layers provided by cloud computing environment 50 (depicted in FIG. 15) is shown. It should be understood in advance that the components, layers, and functions shown in FIG. 16 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the

present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
generating, by a first machine learning model, a single notification for a computing environment;
in response to receiving user responses to a string of the single notification and other single notifications for the computing environment, determining to switch from a single mode to a group mode;
based on the user responses to the string of the single notification and the other single notifications for the computing environment, generating, by a second machine learning model, a group of notifications for the computing environment; and
causing at least one modification to the computing environment in accordance with at least one affirmative user response to the group of notifications.

2. The computer-implemented method of claim 1, wherein a third machine learning model determines the switch from the single mode to the group mode.

3. The computer-implemented method of claim 1, wherein a third machine learning model determines to make another switch from the group mode back to the single mode based on further user responses during the group mode.

4. The computer-implemented method of claim 1, wherein generating the group of notifications for the computing environment comprises:
ranking groups of notifications for the computing environment; and
outputting a highest ranked group of notifications as the group of notifications.

5. The computer-implemented method of claim 1, wherein generating the group of notifications for the computing environment is based, at least in part, on the group of notifications having a highest likelihood of acceptance.

6. The computer-implemented method of claim 1, wherein:
a fourth machine learning model generates a recommendation acceptance probability matrix comprising a probability of acceptance for each past single notification and each past group of notifications; and
the second machine learning model generates the group of notifications for the computing environment based, at least in part, on the recommendation acceptance probability matrix.

7. The computer-implemented method of claim 1, wherein the at least one modification to the computing environment improves a functioning of at least one of a software resource and a hardware resource in the computing environment.

8. A system comprising:
a memory having computer readable instructions; and
one or more processors for executing the computer readable instructions, the computer readable instructions controlling the one or more processors to perform operations comprising:
generating, by a first machine learning model, a single notification for a computing environment;
in response to receiving user responses to a string of the single notification and other single notifications for the computing environment, determining to switch from a single mode to a group mode;
based on the user responses to the string of the single notification and the other single notifications for the computing environment, generating, by a second machine learning model, a group of notifications for the computing environment; and
causing at least one modification to the computing environment in accordance with at least one affirmative user response to the group of notifications.

9. The system of claim 8, wherein a third machine learning model determines the switch from the single mode to the group mode.

10. The system of claim 8, wherein a third machine learning model determines to make another switch from the group mode back to the single mode based on further user responses during the group mode.

11. The system of claim 8, wherein generating the group of notifications for the computing environment comprises:
ranking groups of notifications for the computing environment; and
outputting a highest ranked group of notifications as the group of notifications.

12. The system of claim 8, wherein generating the group of notifications for the computing environment is based, at least in part, on the group of notifications having a highest likelihood of acceptance.

13. The system of claim 8, wherein:
a fourth machine learning model generates a recommendation acceptance probability matrix comprising a probability of acceptance for each past single notification and each past group of notifications; and
the second machine learning model generates the group of notifications for the computing environment based, at least in part, on the recommendation acceptance probability matrix.

14. The system of claim 8, wherein the at least one modification to the computing environment improves a functioning of at least one of a software resource and a hardware resource in the computing environment.

15. A computer program product comprising a computer readable storage medium having program instructions embodied therewith, the program instructions executable by one or more processors to cause the one or more processors to perform operations comprising:
generating, by a first machine learning model, a single notification for a computing environment;
in response to receiving user responses to a string of the single notification and other single notifications for the computing environment, determining to switch from a single mode to a group mode;
based on the user responses to the string of the single notification and the other single notifications for the computing environment, generating, by a second machine learning model, a group of notifications for the computing environment; and
causing at least one modification to the computing environment in accordance with at least one affirmative user response to the group of notifications.

16. The computer program product of claim 15, wherein a third machine learning model determines the switch from the single mode to the group mode.

17. The computer program product of claim 15, wherein a third machine learning model determines to make another switch from the group mode back to the single mode based on further user responses during the group mode.

18. The computer program product of claim 15, wherein generating the group of notifications for the computing environment comprises:
ranking groups of notifications for the computing environment; and
outputting a highest ranked group of notifications as the group of notifications.

19. The computer program product of claim 15, wherein generating the group of notifications for the computing environment is based, at least in part, on the group of notifications having a highest likelihood of acceptance.

20. The computer program product of claim 15, wherein:
a fourth machine learning model generates a recommendation acceptance probability matrix comprising a probability of acceptance for each past single notification and each past group of notifications; and
the second machine learning model generates the group of notifications for the computing environment based, at least in part, on the recommendation acceptance probability matrix.
